(19) United States
(12) Patent Application Publication
(10) Pub. No.: US 2002/0020164 A1
(43) Pub. Date: Feb. 21, 2002

(54) Tubular body with deposited features and method of manufacture therefor

(76) Inventors: Bradley A. Cleveland, Plymouth, MN (US); Frank G. Arcella, Eden Prairie, MN (US); Michael J. Skinner, Eden Prairie, MN (US)

Correspondence Address: Deirdre Megley Kvale, Westman, Champlin & Kelly, International Centre, Suite 1600, 900 Second Avenue South, Minneapolis, MN, 55402-3319, US

(21) Appl. No.: 09/915,758

(22) Filed: Jul. 26, 2001

Related U.S. Application Data
(60) Provisional application No. 60/220,759, filed on Jul. 26, 2000.

(51) Int. Cl. B23P 11/00; B23B 11/00; B23P 17/00

(52) U.S. Cl. 60/39.01; 29/505; 29/527.2; 29/412; 29/34 R; 29/33 T

(57) ABSTRACT

A metal article of manufacture including a tubular body portion and free-formed metal features on the tubular body portion. The free-formed metal features are formed of a layerwise deposition of a molten metal material in a predefined pattern to form the desired free-formed feature or construction.

### CROSS-REFERENCE TO RELATED APPLICATION

The present application claims priority to Provisional Application Ser. No. 60/220,759 filed Jul. 26, 2000 and entitled “ENGINE CASING WITH DEPOSITED FEATURES AND METHOD OF MANUFACTURE THEREFOR.”

### FIELD OF THE INVENTION

The present invention relates to metal articles or casings having a tubular or cylindrical shape. In particular, the present invention relates to tubular or cylindrical shaped articles having free-formed features fabricated from a patterned material deposition.

### BACKGROUND OF THE INVENTION

Metal structures are formed by various manufacturing processes and have varied industrial and commercial applications. Metal structures include tubular or cylindrically shaped articles such an engine casings. Such articles can have detailed shapes or surface features which are typically machined from a thick-walled cylindrical workpiece or cast in a mold including complex mold features which form the complex shape or surface features of the finished article. Machining the finished article from a thick-walled cylindrical workpiece is generally expensive and results in material waste and the design and fabrication of a complex mold to form the desired features increases manufacture difficulty and makes it difficult to accommodate design changes or modification since such design changes requires a new mold for the design modifications or changes. The present invention addresses these and other problems and provides advantages and features not previously recognized nor appreciated.

### SUMMARY OF THE INVENTION

The present invention relates to an article of manufacture having a metal tubular body portion and free-formed metal features on the tubular body portion. The present invention has application for metal engine casings having a tubular engine casing portion and interface features or projections on the tubular engine casing portion. These and various other features as well as advantages which characterize embodiments of the present invention will be apparent upon reading the following detailed description and review of the associated drawings.

### BRIEF DESCRIPTION OF THE DRAWINGS

FIG. 1 schematically illustrates an embodiment of a metal article including a tubular body portion and free-formed metal features on the tubular body portion.

FIG. 2 schematically illustrates a process embodiment for fabricating free-formed features.

FIG. 3-1 and 3-2 schematically illustrate a process embodiment for fabricating a tubular body portion having free-formed metal features.

FIG. 3-3 and 3-4 schematically illustrate an alternate process embodiment for fabricating a tubular body portion having free-formed metal features.

FIG. 4 illustrates an embodiment for contouring a tubular body portion.

FIG. 5 illustrates an embodiment for welding a seam to form a tubular body portion.

FIG. 6 schematically illustrates an embodiment of an article having free-formed features on an inner surface of a tubular body portion.

FIG. 7 is a schematic illustration of an embodiment for forming free-formed features on an outer surface of a tubular metal workpiece.

FIGS. 8-1 and 8-2 schematically illustrate a tubular body portion with free-formed features having a varied profile dimension along a length thereof.

FIG. 9 is a flow chart of process steps for fabricating an article including a tubular body portion with free-formed features.

### DETAILED DESCRIPTION OF ILLUSTRATIVE EMBODIMENTS

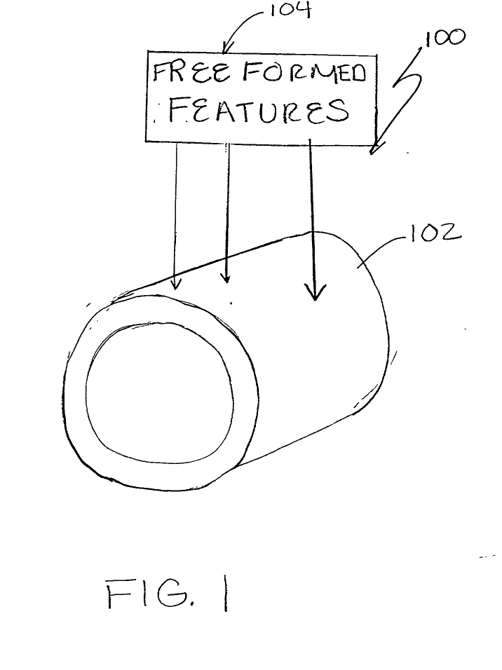

FIG. 1 schematically illustrates one embodiment of a metal article 100 of the present invention including a tubular body portion 102 and free-formed metal features 104 on the tubular body portion 102 as illustrated schematically. The free-formed metal features include surface features such as brackets, mounting structures, surface recesses or contours, surface projections, flanges and/or other surface features including surface features with or without apertures. In one embodiment, the tubular body portion 102 forms a cylindrical engine casing body and the free-formed metal features 104 include various mounting or interface projections, contours or other surface features for the engine casing.

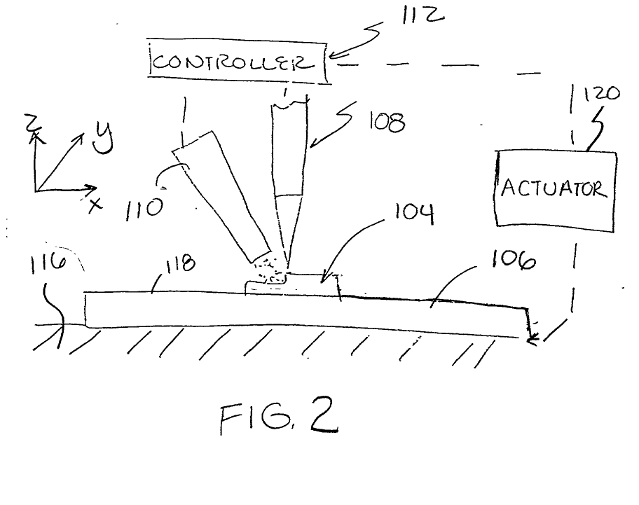

The free-formed metal features 104 are formed on the tubular body portion 102 by a free-form deposition process for fabricating three-dimensional components. In the free-formed deposition process, flowable metal powder is deposited in a patterned layerwise fashion to build a three-dimensional object. The powder is heated by an energy source to essentially form multiple layers of fused powder to form an integral three-dimensional object. In an embodiment illustrated in FIG. 2, the free-formed features 104 are deposited on a workpiece 106 using a laser deposition. As shown, a laser 108, such as a CO₂ laser, melts a flowable metal powder, such as a titanium or alloy powder or other metal, deposited from a nozzle 110 to a molten puddle in the workpiece 106 to form multiple layers of fused powder which cooperatively form the deposited freeformed feature 104. The laser deposition process is done in an inert gas chamber and the power is preferably deposited with a gas assist.

The powder is deposited under control of a controller 112 in a predefined pattern to form the desired free-formed structure having a desired height and shape. The deposition pattern can be controlled based upon computer modeling. In the illustrated embodiment in FIG. 2, the workpiece 106 is a planar metal plate which is supported on a welding table 116 and the free-formed features are deposited on surface 118 of the workpiece 106.

As schematically shown in FIG. 2, welding table 116 is coupled to an actuator 120 which moves welding table 116 under the control of controller 112 relative to laser 108 and nozzle 110 in a pre-defined x-y pattern to form the desired feature shapes. A z-height elevation or standoff distance of the laser 108 and nozzle 110 relative to the workpiece 106 is adjusted or indexed to deposit multiple patterned layers to form the three dimensional free-formed features. Thus, the features are free-formed independent from a mold and without machining a thick-walled cylindrical form. Alternatively, the laser 108 and nozzle 110 can move relative to the workpiece 106 to effect the desired pattern deposit to build the desired free-form shape. Subsequent to the deposition process, the deposited features are machined to achieve the desired finish.

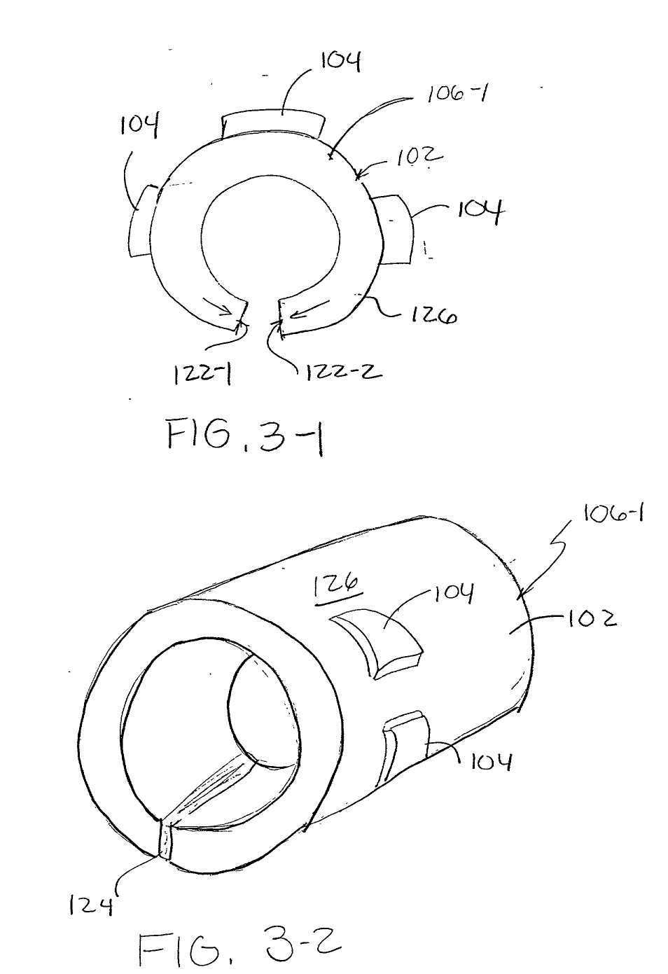

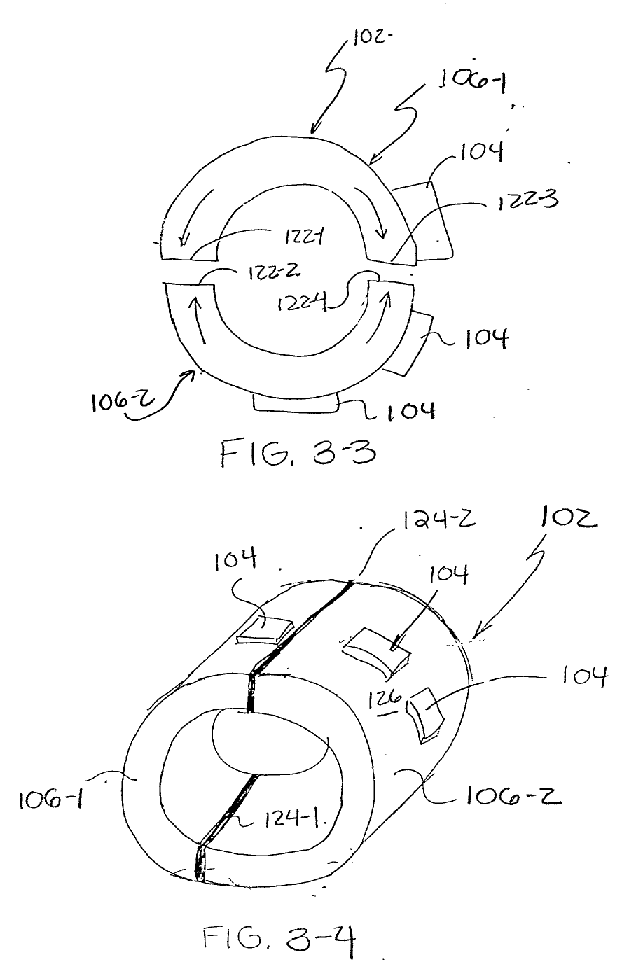

The workpiece 106 including the deposited free-formed features is formed into the tubular body portion 102. The tubular body portion 102 can be formed of a single workpiece section 106-1 having one or more free-formed features 104 as illustrated in FIGS. 3-1 and 3-2 or multiple workpiece sections 106-1, 106-2 as shown in FIGS. 3-3 and 3-4. As cooperatively shown in FIGS. 3-1 and 3-2, opposed edges 122-1, 122-2 of workpiece section 106-1 are joined along a seam 124 as illustrated in FIG. 3-2 to form the tubular body portion 102 having a plurality of free-formed features 104 on an outer surface 126 of the tubular body portion 102. Alternatively, as illustrated in FIGS. 3-3 and 3-4, edges 122-1, 122-2 and 122-3, 122-4 of workpiece sections 106-1, 106-2 are joined along seams 124-1, 124-2 to form the tubular body portion 102.

The tubular body portion 102 is formed from a planar workpiece section by contour shaping the workpiece 106 as illustrated in FIG. 4. The workpiece 106 is contour shaped by heating and creep forming or by other conventional means. In the embodiment illustrated in FIG. 4, the workpiece or section is contoured or formed about a mandrel 130 at an elevated temperature as illustrated schematically by block 132 using pressure as illustrated by arrows 134 to gradually creep or contour the workpiece section 106 about mandrel 130 to form the desired shape as previously described.

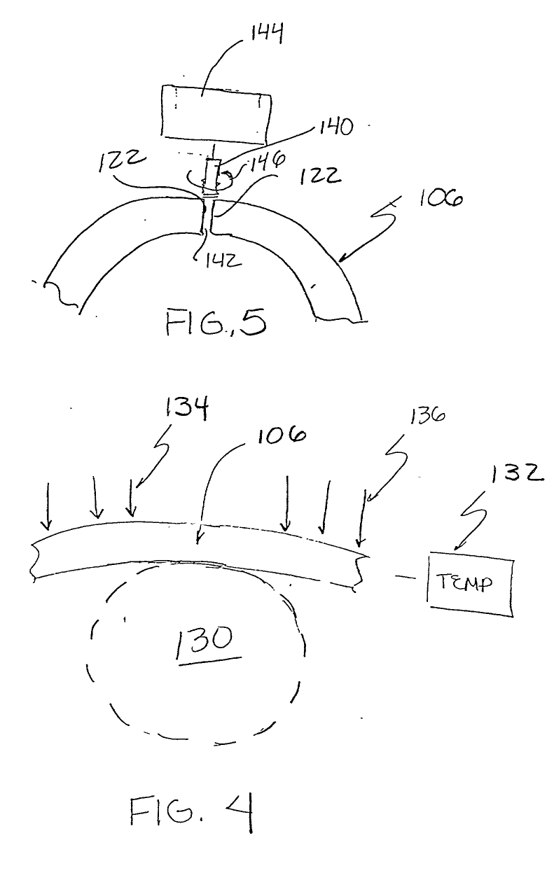

Edge surfaces 122-1, 122-2 of the shaped workpiece 106 are connected along a length thereof to form the seams 124 of the tubular body portion 102. In one embodiment illustrated in FIG. 5, edge surfaces 122-1, 122-2 are welded using friction stir welding. Friction stir welding is a process of welding components parts together using friction heat generated at a welding joint to form a plasticized region which solidifies joining workpiece edges. As shown a non-consumable welding probe 140 is inserted into a gap 142 between edge surface 122-1, 122-2. Probe 140 is coupled to a driver 144 to rotate probe 140 as illustrated by arrow 146 to generate friction heat to form a welded seam joining edge surfaces 122-1, 122-2 to form the tubular body portion 102.

In an embodiment illustrated in FIG. 6, free-formed features 104 are 15 formed on an inner surface 148 of the tubular body portion 102. As shown in FIG. 6, workpiece 106 is shaped or contoured so that the features 104 are on what becomes the inner surface 150 of the tubular body portion 102. Alternatively, free-form features can be fabricated on the inner and outer surfaces of the tubular body portion 102. Features 104 on the inner surface can be fabricated prior to formation of the tubular body portion from the workpiece 106 as illustrated in FIG. 6 and features on the outer surface can be deposited on the fabricated tubular body portion 102.

Alternately, free form features can be deposited on opposed surfaces of a metal plate or workpiece 106 prior to formation of the tubular body portion to form inner and outer surface features on the tubular body portion. The features are formed on a first surface of the workpiece 106 facing the nozzle and then the workpiece 106 is inverted and the features are formed on a second opposed surface of the workpiece 106 facing the nozzle to form inner and outer features. When the workpiece 106 is inverted, the workpiece 106 is supported so that the deposited features on the supported surface are not damaged.

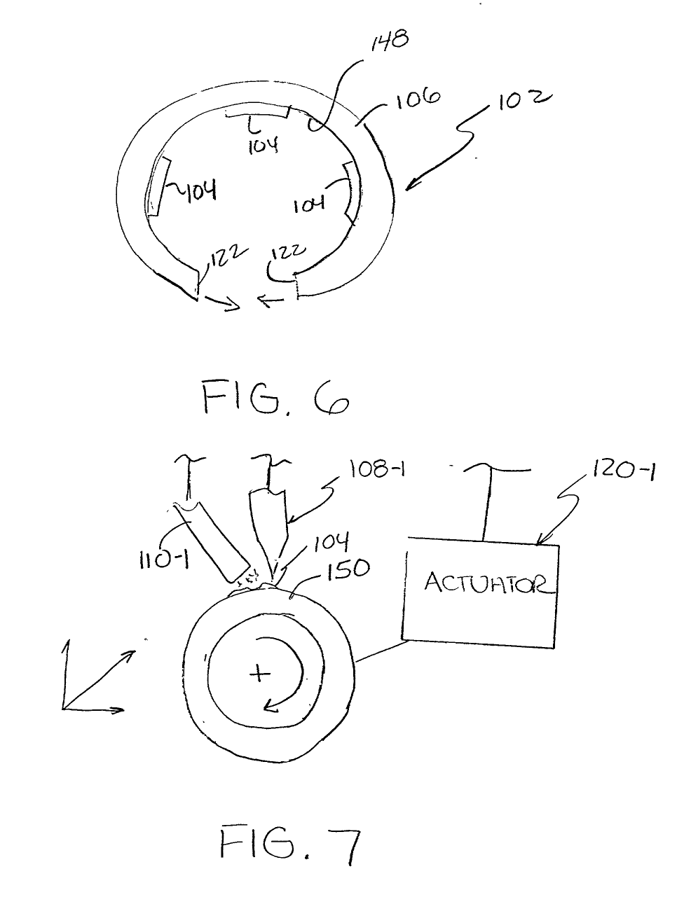

FIG. 7 schematically illustrates an embodiment for depositing features on a tubular metal workpiece 150 to form a tubular body portion 104 with deposited features 104 on an outer surface thereof. The tubular metal workpiece 150 can be fabricated by known forging or manufacturing techniques. As shown metal powder is deposited from a nozzle 108-1 on an outer surface of the tubular workpiece 150 in a layerwise pattern to form the features 104 having the desired shape and dimensions. The powder is heated by a laser 110-1 to form an integral object comprised of fused powder layers.

As shown, actuator 120-1 positions the tubular workpiece 150 in an inert gas chamber. In particular, the actuator 120-1 rotates the tubular workpiece 150 to deposit molten powder about a circumference of the workpiece 150 and axially moves the workpiece 150 to deposit molten powder along a length of the tubular workpiece 150 to form features having a desired shape or contour based upon a desired pattern as previously described. Subsequent to the deposition process, the deposition features can be machined. In one embodiment, the tubular metal workpiece can be axially split into sections to facilitate the machining process and rejoined or welded to form the tubular body portion of the completed article.

FIGS. 8-1 and 8-2 cooperatively illustrates one embodiment of the tubular body portion 102-1 having a varied shape or profile dimension along a length thereof. As shown in FIG. 7-1, an outer diameter dimension 152 and inner diameter dimension 154 (as illustrated by the dotted line) of tubular body portion 102-1 have a varied or changing cross-sectional dimension along a length thereof. The varied dimension of the tubular body portion 102-1 is formed from a contoured or shaped workpiece 106-3 illustrated in FIG. 7-2 having free-formed features 104 thereon illustrated diagrammatically. In the embodiment shown, the workpiece 106-3 has a constant thickness 156 and tapered width 158 dimension to form the varied cross-sectional dimensions when the workpiece 106-3 is formed into a tubular shape.

The constant thickness 156 of the workpiece 106-3 forms a constant wall thickness for the tubular body portion. Alternatively, a tubular body portion with a varied wall thickness can be fabricated from a workpiece having material thickness deposited on the workpiece by a deposition process as described to form a varied wall thickness for the tubular body portion formed therefrom.

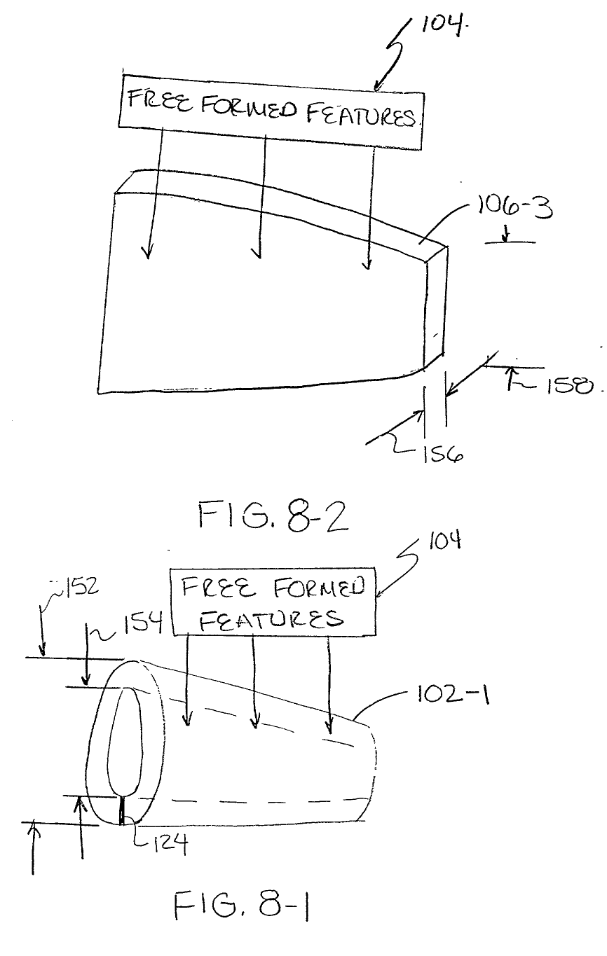

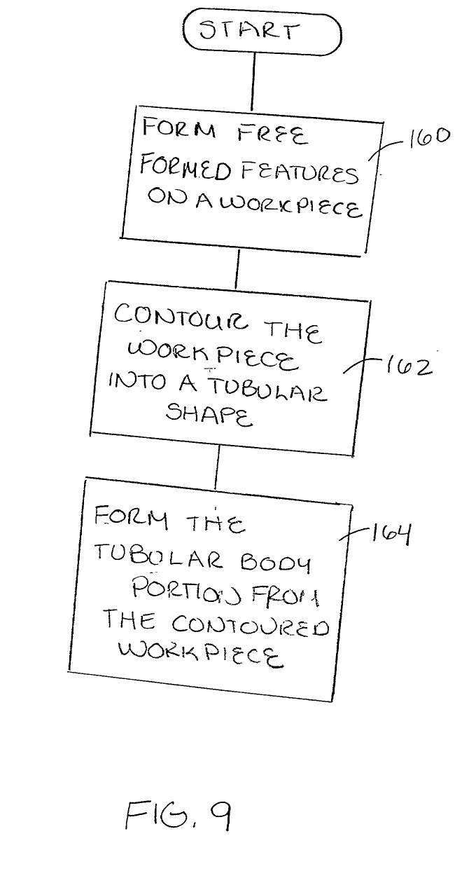

FIG. 8 illustrates a flow chart illustrating process steps for fabricating a metal article including a tubular body portion with free-formed deposited features. As illustrated by block 160 features are formed on a workpiece 106 using a metal deposition process as previously explained. The workpiece 106 is contoured into a tubular shape as illustrated by block 162 and the tubular shaped body is formed from the contoured workpiece as illustrated by block 164.

Although the present invention has been described with reference to preferred embodiments, working skilled in the art will recognize that changes may be made in form and detail without departing from the spirit and scope of the invention. For example, although a titanium material is discussed it should be appreciated, that application is not limited to titanium and in addition, other welding techniques may be used such as conventional arc, laser and E-beam.

What is claimed is:

1. An article comprising:
a tubular body portion including at least one seam along a length thereof; and
free-formed metal features on the tubular body portion integrally formed to the tubular body portion by a patterned deposition of material on the tubular body portion.

2. The article of claim 1 wherein the features are formed on an outer surface of the tubular body portion.

3. The article of claim 1 wherein the features are formed on an inner surface of the tubular body portion.

4. The article of claim 1 wherein the tubular body portion is shaped to form an engine casing body and the free-formed metal features form features of an engine casing.

5. The article of claim 1 wherein the tubular body portion includes one of a constant profile dimension or a variable profile dimension along the length thereof.

6. The article of claim 1 wherein the tubular body portion includes one of a constant inner diameter dimension or a variable inner diameter dimension along the length thereof.

7. The article of claim 1 wherein the at least one seam is welded.

8. The article of claim 1 wherein the tubular body portion and the free-formed metal features are formed of a titanium alloy.

9. A method of forming a tubular shaped article comprising steps of:
depositing a metal powder in patterned layer deposition on a metal workpiece; and
forming a tubular body portion from the metal workpiece.

10. The method of claim 9 wherein the step of forming the tubular body portion comprises:
contour forming the metal workpiece about a mandrel using heat and pressure.

11. The method of claim 9 wherein the tubular body portion is formed from a plurality of workpiece sections and comprising the steps:
contour forming the plurality of workpiece sections using heat and pressure; and
joining the plurality of workpiece sections to form the tubular body portion.

12. The method of claim 9 wherein the step of depositing the metal powder in a patterned layer deposition comprises:
depositing powder from a nozzle into a molten puddle on the workpiece in a patterned layerwise fashion.

13. The method of claim 12 and comprising:
focusing a laser on the workpiece to form the molten puddle.

14. The method of claim 9 wherein the step of forming the tubular body portion comprises:
friction stir welding edges of the workpiece.

15. An article formed using the method steps of claim 9.

16. The article of claim 17 wherein the tubular body portion is an engine casing body and the free-form features are features of an engine casing.

17. The method of claim 9 wherein the workpiece is a metal plate.

18. The method of claim 9 wherein prior to forming the tubular body portion further comprising the step of depositing metal powder in a patterned layer deposition on opposed surfaces of the metal workpiece.

19. A method of fabricating an article comprising the steps of:
depositing a metal powder in a patterned layer deposition on an outer surface of a tubular metal workpiece to form a tubular shaped article with deposited features.

20. The method of claim 19 and further comprising the steps of:
axially splitting the tubular metal workpiece to form workpiece sections;
machining the deposited features on the workpiece sections; and
joining the workpiece sections to form the tubular shaped article with deposited features.

21. An article comprising:
a tubular body portion; and
free-formed metal features on the tubular body portion integrally formed to the tubular body portion by a patterned deposition of material on the tubular body portion.
